(19) United States
(12) Patent Application Publication
(10) Pub. No.: US 2012/0019495 A1
(43) Pub. Date: Jan. 26, 2012

(54) DETECTING DEVICE CAPABLE OF ECONOMIZING ELECTRICITY AND DETECTING METHOD THEREOF

(76) Inventors: Yao-Tsung Chang, New Taipei City (TW); Wen-Chin Wu, New Taipei City (TW); Pin-Hsien Su, New Taipei City (TW)

(21) Appl. No.: 13/183,447

(22) Filed: Jul. 15, 2011

(30) Foreign Application Priority Data
Jul. 26, 2010 (TW) 099124518

(51) Int. Cl. G09G 5/00

(52) U.S. Cl. 345/207; 345/204; 345/211

(57) ABSTRACT

A detecting device capable of economizing electricity includes a first sensor for sensing a first physical quantity, an electronic paper (E-paper) display for displaying information of the first physical quantity, and a controller electrically connected to the first sensor and the E-paper display for controlling the E-paper display to display the information of the changed first physical quantity when the first sensor senses the changed first physical quantity. The controller is further for closing the E-paper display when the first sensor does not sense that the first physical quantity is changed, so that the E-paper display continues displaying the last first physical quantity sensed by the first sensor before the E-paper display is closed.

### BACKGROUND OF THE INVENTION

1. Field of the Invention

The present invention relates to a detecting device, and more particularly, to a detecting device capable of economizing electricity and a detecting method thereof.

2. Description of the Prior Art

A conventional detecting device, such as a thermos with temperature detection, utilizes a thermograph to detect temperature of liquid contained inside the thermos. The conventional detecting device includes a controller and a displaying panel. The controller is for reading datum sensed by the thermos and for displaying the datum on the displaying panel as a reference. The controller and the displaying panel of the conventional detecting device are always functioning after the detecting device is started. Thus, the conventional detecting device has heavy power consumption and short service life. For solving this problem, design of a detecting device capable of economizing electricity and updating sensed result immediately is an important issue of environmental industry.

### SUMMARY OF THE INVENTION

The present invention provides a detecting device capable of economizing electricity and a detecting method thereof for solving above drawbacks.

According to the claimed invention, a detecting device includes a first sensor for sensing a first physical quantity, an electronic paper (E-paper) display for displaying information of the first physical quantity, and a controller electrically connected to the first sensor and the E-paper display for controlling the E-paper display to display the information of the changed first physical quantity when the first sensor senses the changed first physical quantity, and for closing the E-paper display when the first sensor does not sense that the first physical quantity is changed so that the E-paper display continues displaying the information of the last first physical quantity sensed by the first sensor before the E-paper display is closed.

According to the claimed invention, the controller enters a power saving mode or is shut down after the controller closes the E-paper display.

According to the claimed invention, the first sensor outputs an actuating signal to the controller when the first sensor senses that the first physical quantity is changed, so as to actuate the controller to read the changed first physical quantity sensed by the first sensor.

According to the claimed invention, the first physical quantity is temperature, pressure, or illumination.

According to the claimed invention, the detecting device further includes a second sensor electrically connected to the controller for sensing a second physical quantity, and the controlling being further for controlling the E-paper display to display information of the first physical quantity and the second physical quantity simultaneously.

According to the claimed invention, the detecting device further includes a third sensor electrically connected to the controller for sensing a third physical quantity, and for outputting an actuating signal to the controller when the sensed third physical quantity conforms to a specific value so as to actuate the controller to control the E-paper display according to the sensed result of the first sensor.

According to the claimed invention, the third sensor is a timer.

According to the claimed invention, a method of saving electrical energy includes a first sensor sensing a first physical quantity, a controller controlling an electronic paper (E-paper) display to display information of the first physical quantity, and the controller closing the E-paper display when the first sensor does not sense that the first physical quantity is changed so that the E-paper display displays the information of the last first physical quantity sensed by the first sensor before the E-paper display is closed.

According to the claimed invention, the method further includes the controller controlling the E-paper display to display information of the changed first physical quantity when the first sensor senses that the first physical quantity is changed.

According to the claimed invention, the method further includes the controller entering a power saving mode or being shut down after the controller closes the E-paper display as the first sensor continuously senses the first physical quantity.

According to the claimed invention, the method further includes the first sensor outputting an actuating signal to the controller when the first sensor senses that the first physical quantity is changed, so as to actuate the controller to read the changed first physical quantity sensed by the first sensor.

According to the claimed invention, the method further includes a second sensor sensing a second physical quantity, and the controller controlling the E-paper display to display information of the first physical quantity and the second physical quantity simultaneously.

According to the claimed invention, the method further includes a third sensor sensing a third physical quantity, and the third sensor outputting an actuating signal to the controller when the sensed third physical quantity conforms to a specific value, so as to actuate the controller to control the E-paper display according to the sensed result of the first sensor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a detecting device according to a preferred embodiment of the present invention.

FIG. 2 is a flow chart of a detecting method according to the preferred embodiment of the present invention.

FIG. 3 is a flow chart of a detecting method according to the other embodiment of the present invention.

### DETAILED DESCRIPTION

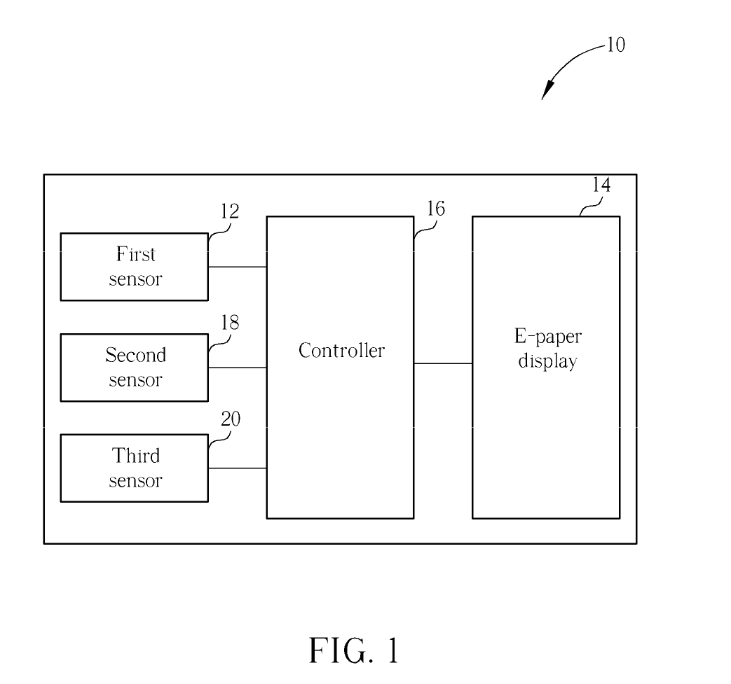

Please refer to FIG. 1. FIG. 1 is a functional block diagram of a detecting device 10 according to a preferred embodiment of the present invention. The detecting device 10 includes a first sensor 12 for sensing a first physical quantity, an electronic paper (E-paper) display 14 for displaying information of the first physical quantity sensed by the first sensor 12, and a controller 16 electrically connected to the first sensor 12 and the E-paper display 14 for controlling the E-paper display 14 to display the information of the changed first physical quantity sensed by the first sensor 12. When the first sensor 12 senses that the first physical quantity is changed, the controller 16 controls the E-paper display 14 to display the changed first physical quantity. When the first sensor 12 senses that the first physical quantity is not changed, the controller 16 closes the E-paper display 14. Because the information displayed on the E-paper display 14 can keep for a while after the power is shut down, so that the E-paper display 14 can continue displaying the information of the last first physical quantity sensed by the first sensor 12 before the E-paper display 14 is closed.

The controller 16 enters a power saving mode or is shut down after the E-paper display 14 is closed by the controller 16, so that the detecting device 10 can close the controller 16 and the E-paper display 14 for economizing the electricity when the first physical quantity is not changed. On the other hand, when the controller 16 and the E-paper display 14 are closed, and the first sensor 12 sensed that the first physical quantity is changed, the first sensor 12 can output an actuating signal to the controller 16, so as to actuate the controller 16 to read the changed first physical quantity sensed by the first sensor 12 and to control the E-paper display 14 to display the changed first physical quantity. Generally, the first physical quantity can be temperature, pressure, illumination, and so on, which means that the first sensor 12 can be a thermograph, a manometer, a lux meter, and so on.

Besides, the detecting device 10 can further include a second sensor 18 electrically connected to the controller 16 for augmenting functions of the detecting device 10. The second detector 18 can detect a second physical quantity, and the controller 16 can control the E-paper display 14 to simultaneously display the first physical quantity and the second physical quantity. For example, the detecting device 10 can be a container capable of detecting the temperature. The first sensor 12 can be utilized for detecting internal temperature (the first physical quantity) of liquid contained inside the container, and the second sensor 18 can be utilized for detecting external temperature (the second physical quantity) of the environment whereon the container is placed, so that a user can read temperature difference between the first physical quantity and the second physical quantity via the information on the E-paper display 14, so as to judge thermal isolation of the container. Furthermore, the detecting device 10 can further include a third sensor 20 electrically connected to the controller 16 for sensing a third physical quantity. When the third physical quantity conforms to a specific condition, the third sensor 20 is for outputting an actuating signal to the controller 16, so as to actuate the controller 16 to control the E-paper display 14 according to the sensed result of the first sensor 12 or of the second sensor 18 (or according to the sensed result of the first sensor 12 and the second sensor 18 at the same time). For example, the third sensor 20 can be a timer. As a predetermined period is counted down, the timer can output the actuating signal to wake up the controller 16, which enters the power saving mode or is shut down, so as to actuate the controller 16 to read the sensed result of the first sensor 12 or the second sensor 18 and to determine whether the E-paper display 14 displays the sensed result. The sensed physical quantity of the first sensor 12, the second sensor 18, and the third sensor 20 are not limited to the said of the above-mentioned embodiment, and depend on actual demand. Generally, the sensed physical quantity can also be sound volume, voltage, current, electricity, weight, flow rate, speed, acceleration, longitude and latitude, height, length, time, and so on.

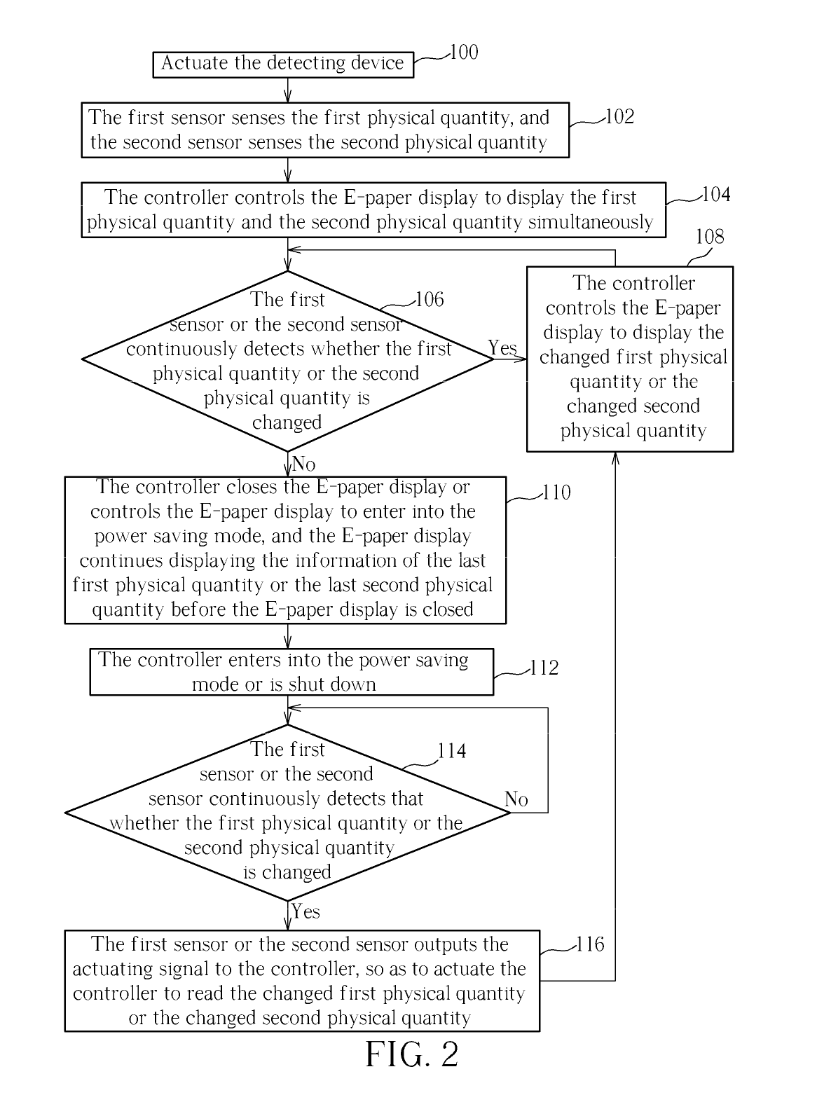

Please refer to FIG. 2. FIG. 2 is a flow chart of a detecting method according to the preferred embodiment of the present invention. The detecting method includes following steps:

Step 100: Actuate the detecting device 10.

Step 102: The first sensor 12 senses the first physical quantity, and the second sensor 18 senses the second physical quantity.

Step 104: The controller 16 controls the E-paper display 14 to display the first physical quantity and the second physical quantity simultaneously.

Step 106: The first sensor 12 continuously detects whether the first physical quantity is changed, or the second sensor 18 continuously detects whether the second physical quantity is changed. If yes, execute step 108. If no, execute step 110.

Step 108: The controller 16 controls the E-paper display 14 to display the changed first physical quantity or the changed second physical quantity, and back to step 106.

Step 110: The controller 16 closes the E-paper display 14 or controls the E-paper display 14 to enter into the power saving mode, and the E-paper display 14 continues displaying the information of the last first physical quantity sensed by the first sensor 12 or the last second physical quantity sensed by the second sensor 18 before the E-paper display 14 is closed, and execute step 112.

Step 112: The controller 16 enters into the power saving mode or is shut down, and execute step 114.

Step 114: The first sensor 12 continuously detects that whether the first physical quantity is changed, or the second sensor 18 continuously detects that whether the second physical quantity is changed. If yes, execute step 114. If no, execute step 116.

Step 116: The first sensor 12 or the second sensor 18 outputs the actuating signal to the controller 16, so as to actuate the controller 16 to read the changed first physical quantity sensed by the first sensor 12 or the changed second physical quantity sensed by the second sensor 18, and back to step 108.

The detailed description is illustrated as follows. First, the first sensor 12 and the second sensor 18 respectively detect the first physical quantity and the second physical quantity. The controller 16 reads the first physical quantity sensed by the first sensor 12 and the second physical quantity sensed by the second sensor 18, and displays the physical quantity on the E-paper display 14, so that the user can view information of the first physical quantity and the second physical quantity on the E-paper display 14 for distinguishing their difference. After, the first sensor 12 or the second sensor 18 continuously detects that whether the first physical quantity or the second physical quantity is changed. As the first physical quantity or the second physical quantity is changed, the controller 16 reads the changed first physical quantity or the changed second physical quantity, and displays the information on the E-paper display 14. As the first physical quantity or the second physical quantity is not changed, the controller 16 closes the E-paper display 14, and the E-paper display 14 can still display the last first physical quantity sensed by the first sensor 12 or the last second physical quantity sensed by the second sensor 18 before the E-paper display 14 is closed according to the specific characteristic of the E-paper display 14. After the E-paper display 14 is closed, the controller 16 enters into the power saving mode or is shut down for economizing the electricity. Then, the first sensor 12 or the second sensor 18 continuously detects that whether the first physical quantity or the second physical quantity is changed when the controller 16 enters into the power saving mode or is shut down. As the first physical quantity or the second physical quantity is not changed, the detecting device 10 keeps at an initial status, which means the E-paper display 14 is closed, and the controller 16 is at the power saving mode or is shut down. As the first physical quantity or the second physical quantity is changed, the first sensor 12 or the second sensor 18 outputs the actuating signal to the controller 16, so as to actuate the controller 16 to read the changed first physical quantity sensed by the first sensor 12 or the changed second physical quantity sensed by the second sensor 18 and to display the changed first physical quantity or the changed second physical quantity on the E-paper display 14, so that the detecting device 10 has auto-detecting function and real time updating function. It should be mentioned that the detecting device 10 continuously repeats the above-mentioned steps for updating the newest first physical quantity and the newest second physical quantity on the E-paper display 14 until the user disables the functions.

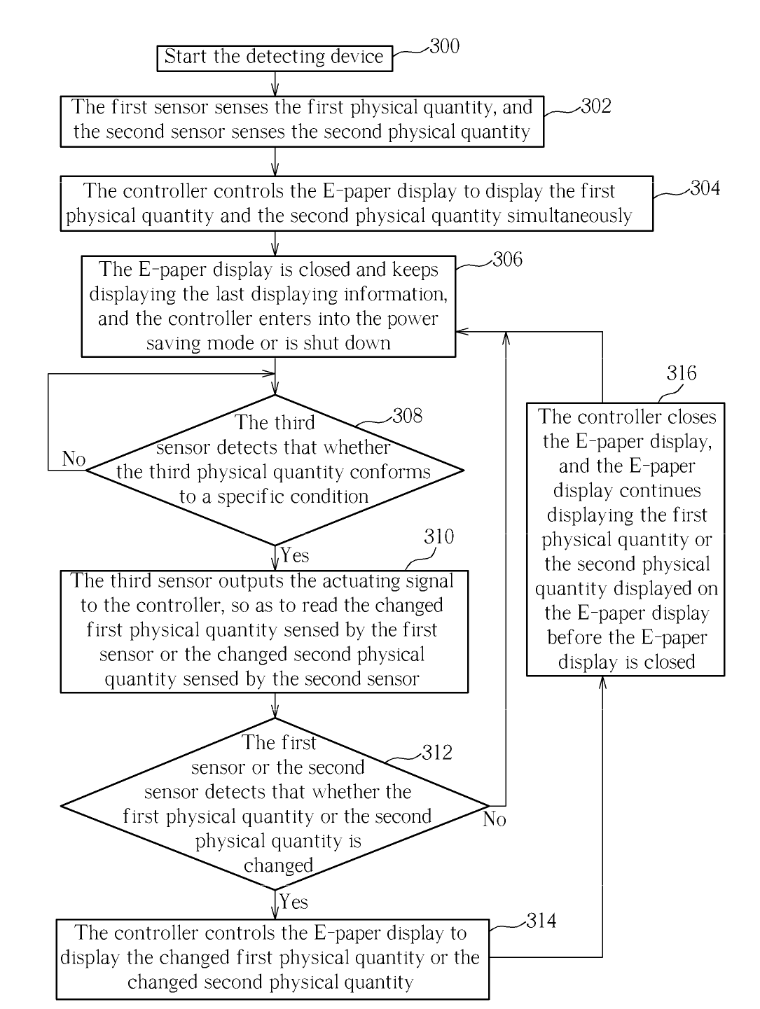

In addition, the detecting device 10 can further include the third sensor 20 for providing time detecting function. Please refer to FIG. 3. FIG. 3 is a flow chart of a detecting method according to the other embodiment of the present invention. The detecting method includes following steps:

Step 300: Start the detecting device 10.

Step 302: The first sensor 12 senses the first physical quantity, and the second sensor 18 senses the second physical quantity.

Step 304: The controller 16 controls the E-paper display 14 to display the first physical quantity and the second physical quantity simultaneously.

Step 306: The E-paper display 14 is closed and keeps displaying the last displaying information, and the controller 16 enters into the power saving mode or is shut down.

Step 308: The third sensor 20 detects that whether the third physical quantity conforms to a specific condition. If no, execute step 308. If yes, execute step 310.

Step 310: The third sensor 20 outputs the actuating signal to the controller 16, so as to actuate the controller 16 to read the changed first physical quantity sensed by the first sensor 12 or the changed second physical quantity sensed by the second sensor 18, and back to step 312.

Step 312: The first sensor 12 detects that whether the first physical quantity is changed, or the second sensor 18 detects that whether the second physical quantity is changed. If no, back to step 306. If yes, execute step 314.

Step 314: The controller 16 controls the E-paper display 14 to display the changed first physical quantity or the changed second physical quantity, and execute step 316.

Step 316: The controller 16 closes the E-paper display 14, and the E-paper display 14 continues displaying the first physical quantity or the second physical quantity displayed on the E-paper display 14 before the E-paper display is 14 closed, and execute step 306.

The detailed description is as follows. First, the first sensor 12 and the second sensor 18 respectively detect the first physical quantity and the second physical quantity. The controller 16 reads the first physical quantity sensed by the first sensor 12 and the second physical quantity sensed by the second sensor 18, and displays the physical quantity on the E-paper display 14, so that the user can read the difference between the first physical quantity and the second physical quantity on the E-paper display 14. Then, the E-paper display 14 is closed and keeps displaying the last displaying information, and the controller 16 enters into the power saving mode or is shut down for economizing the electricity. After, the third sensor 20 detects that whether the third physical quantity conforms to the specific condition. As the third physical quantity does not conform to the specific condition, the controller 16 keeps at the power saving mode or at the closed status, and the third sensor 20 continuously detects variation of the third physical quantity for next comparison. As the third physical quantity conforms to the specific condition, the third sensor 20 outputs the actuating signal to the controller 16, so as to actuate the controller 16 to read the first physical quantity sensed by the first sensor 12 or the second physical quantity sensed by the second sensor 18. For example, the third sensor 20 can be the timer. When the counting period of the timer is greater than a predetermined period, the controller 16 is actuated to read the first physical quantity sensed by the first sensor 12 or the second physical quantity sensed by the second sensor 18. Then, as the first physical quantity or the second physical quantity is not changed, the controller 16 enters into the power saving mode or is shut down again, and the third sensor 20 keeps detecting that whether the third physical quantity conforms to the specific condition. As the first physical quantity or the second physical quantity is changed, the controller 16 controls the E-paper display 14 to display the changed first physical quantity or the changed second physical quantity. Then the E-paper display 14 is closed and continues displaying the last first physical quantity or the last second physical quantity, and the controller 16 enters into the power saving mode or is shut down. And after, the third sensor 20 continuously detects that whether the latest third physical quantity conforms to the specific condition. Thus, the detecting device 10 can detect the physical quantity and update the displaying information automatically.

In conclusion, the detecting device 10 of the present invention can utilize the first sensor 12, the second sensor 18, and the third sensor 20 to immediately update the physical quantity sensed by the sensors according to the user's demand. For example, when the detecting device 10 includes the first sensor 12 and the second sensor 18 placed on different surroundings, the user can read the difference between the first physical quantity and the second physical quantity displayed on the E-paper display 14, and the detecting device 10 can determine whether to actuate the controller 16 to update the first physical quantity or the second physical quantity displayed on the E-paper display 14 according to the sensed results of the first sensor 12 or the second sensor 18, or according to the first sensor 12 and the second sensor 18 at the same time. For example, the detecting device 10 can be disposed on a thermos, and the first sensor 12 and the second sensor 18 can respectively be the thermographs disposed inside and outside the thermos. The E-paper display 14 can display the temperature sensed by the first sensor 12 immediately when temperature of liquid disposed inside the thermos is changed, and display the room temperature sensed by the second sensor 18. In addition, when the detecting device 10 includes the first sensor 12, the second sensor 18, and the third sensor 20 applied for different conditions, the detecting device 10 can determine whether to actuate the controller 16 to read the sensed result of the first sensor 12 or the second sensor 18 according to the sensed result of the third sensor 20. For example, the detecting device 10 actuates the controller 16 according to the sensed result that whether the third physical quantity conforms to the specific condition. The detecting device 10 further determines whether the E-paper display 14 updates the displaying information according to the sensed result of the first sensor 12 or of the second sensor 18. Generally, the third sensor 18 can be the timer, and the detecting device 10 can actuate the controller 16 to read the temperature values of the thermograph when the predetermined period is counted down by the timer, and the controller 16 can determine whether the E-paper display 14 updates the displaying information according to the sensed result of the first sensor 12 and the second sensor 18.

Comparing to the prior art, the detecting device of the present invention closes the E-paper display and the controller when the physical quantity sensed by the sensor is not changed, and the E-paper display continues displaying the last physical quantity sensed by the sensor before the E-paper display is closed. In addition, as the physical quantity is changed, the controller is actuated by the sensor, so as to read the changed physical quantity immediately and to control the E-paper display to display the changed physical quantity. Therefore, the detecting device of the present invention not only can update the sensed physical quantity immediately, but also can close the controller and the E-paper display for economizing the electricity as the sensed physical quantity is not changed.

Those skilled in the art will readily observe that numerous modifications and alterations of the device and method may be made while retaining the teachings of the invention.

What is claimed is:

1. A detecting device comprising:
a first sensor for sensing a first physical quantity;
an electronic paper (E-paper) display for displaying information of the first physical quantity; and
a controller electrically connected to the first sensor and the E-paper display for controlling the E-paper display to display the information of the changed first physical quantity when the first sensor senses the changed first physical quantity, and for closing the E-paper display when the first sensor does not sense that the first physical quantity is changed so that the E-paper display continues displaying the information of the last first physical quantity sensed by the first sensor before the E-paper display is closed.

2. The detecting device of claim 1, wherein the controller enters a power saving mode or is shut down after the controller closes the E-paper display.

3. The detecting device of claim 2, wherein the first sensor outputs an actuating signal to the controller when the first sensor senses that the first physical quantity is changed, so as to actuate the controller to read the changed first physical quantity sensed by the first sensor.

4. The detecting device of claim 1, wherein the first physical quantity is temperature, pressure, or illumination.

5. The detecting device of claim 1 further comprising:
a second sensor electrically connected to the controller for sensing a second physical quantity, and the controlling being further for controlling the E-paper display to display information of the first physical quantity and the second physical quantity simultaneously.

6. The detecting device of claim 1 further comprising:
a third sensor electrically connected to the controller for sensing a third physical quantity, and for outputting an actuating signal to the controller when the sensed third physical quantity conforms to a specific value so as to actuate the controller to control the E-paper display according to the sensed result of the first sensor.

7. The detecting device of claim 6, wherein the third sensor is a timer.

8. A method of saving electrical energy comprising:
a first sensor sensing a first physical quantity;
a controller controlling an electronic paper (E-paper) display to display information of the first physical quantity; and
the controller closing the E-paper display when the first sensor does not sense that the first physical quantity is changed so that the E-paper display displays the information of the last first physical quantity sensed by the first sensor before the E-paper display is closed.

9. The method of claim 8 further comprising:
the controller controlling the E-paper display to display information of the changed first physical quantity when the first sensor senses that the first physical quantity is changed.

10. The method of claim 8 further comprising:
the controller entering a power saving mode or being shut down after the controller closes the E-paper display as the first sensor continuously senses the first physical quantity.

11. The method of claim 10 further comprising:
the first sensor outputting an actuating signal to the controller when the first sensor senses that the first physical quantity is changed, so as to actuate the controller to read the changed first physical quantity sensed by the first sensor.

12. The method of claim 8 further comprising:
a second sensor sensing a second physical quantity; and
the controller controlling the E-paper display to display information of the first physical quantity and the second physical quantity simultaneously.

13. The method of claim 8 further comprising:
a third sensor sensing a third physical quantity; and
the third sensor outputting an actuating signal to the controller when the sensed third physical quantity conforms to a specific value, so as to actuate the controller to control the E-paper display according to the sensed result of the first sensor.
